(19) United States
(12) Patent Application Publication
(10) Pub. No.: US 2015/0029299 A1
(43) Pub. Date: Jan. 29, 2015

(54) PARTICIPANT-CENTERED DISTRIBUTED VIDEO CONFERENCING APPARATUS AND METHOD

(71) Applicant: Electronics and Telecommunications Research Institute, Daejeon (KR)

(72) Inventors: Seung Han CHOI, Daejeon (KR); Juyoung PARK, Daejeon (KR); Young Soo SHIN, Daejeon (KR)

(73) Assignee: Electronics and Telecommunications Research Institute, Daejeon (KR)

(21) Appl. No.: 14/092,780

(22) Filed: Nov. 27, 2013

(30) Foreign Application Priority Data
Jul. 23, 2013 (KR) 10-2013-0087004

(51) Int. Cl. H04N 7/15

(52) U.S. Cl. CPC H04N 7/15
USPC 348/14.08

(57) ABSTRACT

To conduct video conferencing between a plurality of distributed clients, a distributed controller receives a request from a first distributed client for a packet from a second distributed client selected as the main speaker, and a distributed media processor creates a switching entry for switching packets from the first and second distributed clients, in response to a request from the distributed controller. The distributed controller sends a packet transmission request to the second distributed client, and the distributed media processor receives a packet from the second distributed client and sends the received packet to the first distributed client based on the switching entry.

### CROSS-REFERENCE TO RELATED APPLICATION

This application claims priority to and the benefit of Korean Patent Application No. 10-2013-0087004 filed in the Korean Intellectual Property Office on Jul. 23, 2013, the entire contents of which are incorporated herein by reference.

### BACKGROUND OF THE INVENTION

(a) Field of the Invention

The present invention relates to a video conferencing apparatus and method, and more particularly, to a participant-centered distributed video conferencing apparatus and method.

(b) Description of the Related Art

As multimedia communication services have become popular in recent years, video conference systems based on video communication which enables people in different locations to have a face-to-face meeting are increasingly being used. Video conference systems are evolving toward providing a telepresence service. Telepresence is a service that provides highly realistic video conferencing and enables users to feel as if they are sitting across the table from each other.

Conventional telepresence and high-resolution video conferencing are provided based on a centralized server such as a multipoint control unit (MCU). A plurality of conference participants send images and data by using their terminals, and the server processes the images and data sent from the participants and provides them to other terminals or transmits them to all the terminals to share data.

A video conferencing apparatus based on such a centralized server has the following problems.

First, the server specifies the display of a main speaker or allows all the conference participants to see only the conference display created by the server, by controlling the video and audio displays of conference participants. Accordingly, the conference participants cannot see the speakers they want to see.

Second, the provision of telepresence service causes more load on the network due to increased bandwidth as high-resolution video packets are sent to all the participants' terminals.

Finally, as audio and video traffic from all the participants' terminals is concentrated around the server, it causes the problems of packet loss, packet delay, etc., and therefore makes it difficult to enhance the scalability of the telepresence service.

### SUMMARY OF THE INVENTION

The present invention has been made in an effort to provide an apparatus and method which perform video conferencing centered on conference participants, in a video conference service that provides a telepresence service.

An exemplary embodiment of the present invention provides a video conferencing method for a video conferencing apparatus, the method including: a distributed controller receiving a request from a first distributed client for a packet from a second distributed client selected as a main speaker; a distributed media processor creating a switching entry for switching packets from the first and second distributed clients, in response to a request from the distributed controller; the distributed controller sending a packet transmission request to the second distributed client; and the distributed media processor receiving a packet from the second distributed client and sending the received packet to the first distributed client based on the switching entry.

In the creating of a switching entry for switching a packet from the second distributed client, the identifier of the first distributed client and the identifier of the second distributed client may be added to the switching entry.

The sending of the received packet to the first distributed client may include: extracting an identifier from the packet received from the second distributed client; identifying the first distributed client by referring to the switching entry based on the extracted identifier; and sending the packet to the identified distributed client.

The video conferencing method may further include: upon receiving a conference participation request message from a third distributed client, the distributed controller requesting the distributed media processor to create a switching entry; the distributed media processor creating an identifier-based switching entry for a video conference group to which the third distributed client belongs; the distributed media processor receiving a packet from the third distributed client; and the distributed media processor transmitting the packet to the distributed clients corresponding to the participants belonging to the video conference group.

In the generating of an identifier-based switching entry, a group identifier assigned to the video conference group, the identifier of the third distributed client, and the identifiers of the distributed clients participating in the video conference group may be added to the switching entry.

The transmitting of the packet to the distributed clients may include: extracting the group identifier or the identifier of the third distributed client from the packet; acquiring the identifiers of the distributed clients, i.e., the participants, by analyzing the switching entry based on the extracted identifier; and transmitting the packet to the distributed clients corresponding to the acquired identifiers.

The packet received from the third distributed client may be a packet having a first resolution that is lower than a set resolution, and the packet received from the second distributed client may be a packet having a second resolution that is higher than the set resolution.

The video conferencing method may further include: when a distributed client receives a first-resolution packet, displaying, on a display screen divided into a first region and a second region, a video corresponding to the first-resolution located below the second region; and when the distributed client receives a second-resolution packet, displaying a video corresponding to the second-resolution packet in the second region.

The video conferencing method may further include, prior to the receiving of a packet request from the first distributed client, the first distributed client selecting one of the videos having the first resolution displayed in the first region, and selecting the distributed client who has provided the selected video as the main speaker.

In the sending of a packet transmission request to the second distributed client, if the second distributed client has transmitted a second-resolution packet in response to a request from another distributed client, the distributed controller may not send a packet transmission request based on the request from the first distributed client.

Another exemplary embodiment of the present invention provides a video conferencing apparatus which conducts video conferencing between a plurality of distributed clients, the apparatus including: a plurality of distributed media processors that send or receive packets to and from the plurality of distributed clients and correspond to the plurality of distributed clients; and a distributed controller that requests the distributed media processors to create an identifier-based switching entry for packet transmission to the distributed media processors, upon receiving a conference participation request from the distributed clients or a request from the distributed clients for a packet from the distributed client who is a main speaker, wherein each of the distributed media processors may create a switching entry and transmit a packet received from the distributed clients to other distributed clients, based on the created switching entry.

The video conferencing apparatus may further include: a packet receiver that receives a packet from the distributed clients; a switching entry processor that creates an identifier-based switching entry in response to a request from the distributed controller; an identifier processor that extracts an identifier from the packet received from the distributed clients, and creates a switching entry based on the extracted identifier to identify a target to send the packet to; and a packet transmitter that transmits the received packet to the distributed client corresponding to the identified target.

The switching entry processor may generate a first switching entry for switching packets from the first distributed client and second distributed client selected as the main speaker and a second switching entry for switching a packet from the third distributed client, and the second switching entry may be used for switching a packet having a first resolution that is lower than a set resolution, and the first switching entry may be used for switching a packet having a second resolution that is higher than the set resolution.

The first switching entry may be created based on the identifier of the first distributed client and the identifier of the second distributed client, and the second switching entry may be created based on a group identifier assigned to the video conference group to which the third distributed client belongs, the identifier of the third distributed client, and the identifiers of the distributed clients participating in the video conference group.

The distributed controller may request the second distributed client to provide a second-resolution packet in response to a request from the first distributed client, who is the main speaker, and the distributed media processor may forward the second-resolution packet received from the second distributed client to the first distributed client based on the first switching entry. The distributed media processor may send the first-resolution packet received from the third distributed client to other distributed clients belonging to the same video conference group as the third distributed client, based on the second switching entry.

Yet another exemplary embodiment of the present invention provides a distributed client device, which conducts video conferencing via a network in connection with a video conferencing apparatus including a distributed controller and distributed media processors, the device including: a conference participation requestor that makes a request for participation in a conference while sending a video conference participation request message to the distributed controller; a first-resolution packet processor that sends or receives packets having a first resolution that is lower than a set resolution; a second-resolution packet processor that sends or receives packets having a second resolution that is higher than the set resolution; and a display section that divides the display screen into a first region and a second region, the first region displaying videos corresponding to first-resolution video packets, and the second region displaying videos corresponding to second-resolution video packets.

The distributed client device may further include a main speaker selector that selects the main speaker from among a plurality of participants in the video conference, wherein the second-resolution packet processor may receive a second-resolution packet sent from the distributed client selected as the main speaker.

The main speaker selector may select the main speaker from among a plurality of participants who have provided the first-resolution packets displayed in the first region.

### BRIEF DESCRIPTION OF THE DRAWINGS

FIG. 1 is a view showing a video conferencing apparatus according to an exemplary embodiment of the present invention.

FIG. 2 is a view showing the structure of a distributed telepresence media processor according to an exemplary embodiment of the present invention.

FIG. 3 is a view showing the structure of a distributed client according to an exemplary embodiment of the present invention.

FIG. 4 is an illustration showing a screen displayed on the distributed client according to an exemplary embodiment of the present invention.

FIG. 5 is a flowchart of a distributed video conferencing method for a first-resolution packet according to an exemplary embodiment of the present invention.

FIG. 6 is a flowchart of a distributed video conferencing method for a second-resolution packet according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a participant-centered distributed video conferencing apparatus and method according to an exemplary embodiment of the present invention will be described with reference to the drawings.

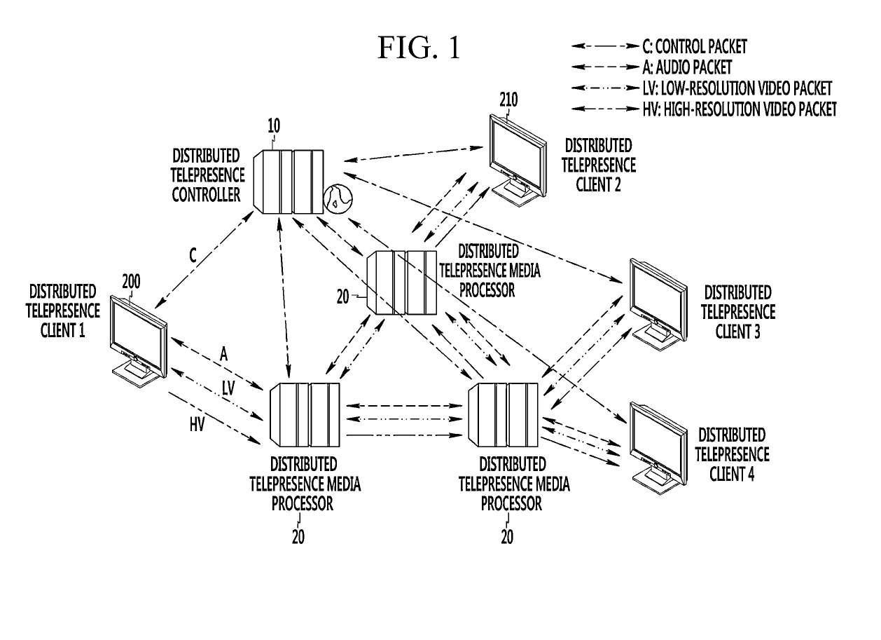

FIG. 1 is a view showing a video conferencing apparatus according to an exemplary embodiment of the present invention.

As shown in FIG. 1, a video conferencing apparatus 100 according to the exemplary embodiment of the present invention includes a distributed telepresence controller 10 and a distributed telepresence media processor 20, and enables video conferencing by communicating with a plurality of distributed telepresence clients 200.

The distributed telepresence media processor (hereinafter referred to as a distributed media processor for convenience of explanation) 20 is provided in a plural number, and sends and receives media data in connection with at least one distributed telepresence client (hereinafter referred to as a distributed client for convenience of explanation) 200. A plurality of distributed media processors 20 are disposed in a distributed manner as shown in FIG. 1, and send or receive media data to or from the distributed client in a given area. Moreover, each distributed media processor 20 provides telepresence service to the distributed clients in connection with the distributed telepresence controller 10.

Particularly, the distributed media processor according to the exemplary embodiment of the present invention creates an identifier-based switching entry, and sends and receives packets between the distributed clients based on the identifier-based switching entry.

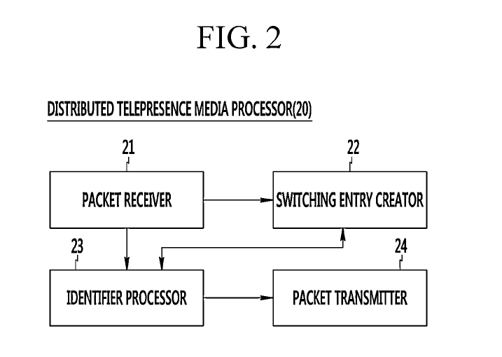

FIG. 2 is a view showing the structure of a distributed telepresence media processor according to an exemplary embodiment of the present invention.

The distributed telepresence media processor, that is, the distributed media processor 20, includes a packet receiver 21, a switching entry processor 22, an identifier processor 23, and a packet transmitter 24.

The packet receiver 21 receives packets from the distributed clients 200 or other distributed media processors. The packets may be video packets or audio packets, and the packets include a packet having a first resolution that is lower than a set resolution and a packet having a second resolution that is higher than the first resolution.

The switching entry processor 22 creates an identifier-based switching entry in response to a request from the distributed telepresence controller 10. The switching entry processor 22 provides the distributed media processor 20 with information about clients participating in the video conference, provided from the distributed telepresence controller 10.

The identifier-based switching entry is created based on the identifier of each distributed client. Here, the identifier may be an identifier which indicates a distributed client, an identifier which indicates a sent/received packet, or an identifier for a video conference group in which distributed clients are participating. The identifier-based switching entry may be classified into a first identifier-based switching entry for sending or receiving a first-resolution packet and a second identifier-based switching entry for sending or receiving a second-resolution packet.

The identifier-based switching entry can be created for each video conference group formed between distributed clients, and can include identifiers of distributed clients participating in a video conference group. For example, the identifiers of distributed clients registered as participants can be matched with the group identifier assigned to the video conference group. Moreover, in response to a request from the distributed telepresence controller 10, a matching relationship can be added based on the identifiers of distributed clients to or from which packets should be sent or received. Such an identifier-based switching entry can function as a first identifier-based switching entry for sending or receiving a first-resolution packet.

Also, the identifier-based switching entry can include a path along which packets are sent or received between distributed clients. For example, path information representing packet transmission from a first distributed client to a second distributed client may be formed. Based on such information, a packet from the first distributed client can be sent to the second distributed client. Such an identifier-based switching entry can function as a second identifier-based switching entry for sending or receiving a second-resolution packet.

The identifier processor 23 extracts the identifier of a distributed client from a packet received by the packet receiver 21, and selects a target to send the packet to, by referring to switching entries created by the switching entry generator 22, based on the extracted identifier. Then, the identifier processor 23 sends a packet transmission request while forwarding the identifier of the selected target to the packet transmitter 24. For example, the identifier processor 23 identifies the identifier of the second distributed client to send the packet to, by referring to the switching entry based on the identifier of the first distributed client contained in the packet, and forwards the identifier of the second distributed client to the packet transmitter 24. Here, the second distributed client may be another participant in the video conference group in which the first distributed client is participating.

The packet transmitter 24 sends the packet received by the packet receiver 21 to the relevant distributed client, based on the identifier provided from the identifier processor 23. That is, the packet transmitter 24 sends the received packet to the second distributed client, based on the identifier of the second distributed client (or the packet transmitter 24 sends the received packet to the distributed media processor managing the second distributed client so as to send it to the second distributed client).

Meanwhile, the distributed telepresence controller (hereinafter referred to as the distributed controller for convenience of explanation) 10 provides telepresence service to the distributed clients 200, and allows packets to be sent or received between the distributed clients in connection with each distributed media processor 20. In the exemplary embodiment of the present invention, the distributed controller 10 makes a request to create an identifier-based entry while providing identifier information of distributed clients to each distributed media controller, in response to a conference participation request from a distributed client participating in a video conference. Thereafter, data packets sent or received between the distributed clients based on an identifier-based entry are sent to or received from the relevant distributed clients through the distributed media processors, rather than through the distributed controller 10.

In particular, as shown in FIG. 1, control packets associated with making a request for participation in a conference or accepting the request are sent or received directly between the distributed controller 10 and the distributed clients 200. On the other hand, data packets, i.e., audio packets or video packets (video packets having the first and second resolutions), are sent or received between the distributed media processors 20 and the distributed clients 200 without passing through the distributed controller 10. Accordingly, traffic concentration on the distributed controller 10 can be avoided.

A distributed client 200 that receives a telepresence service through the video conferencing apparatus 100 having the above-described structure has the following structure.

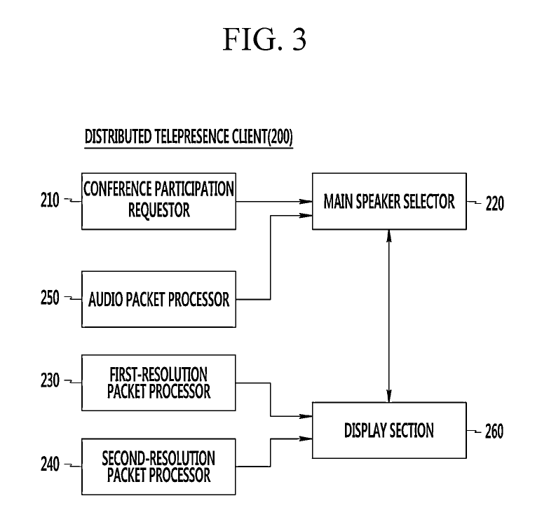

FIG. 3 is a view showing the structure of a distributed client according to an exemplary embodiment of the present invention.

As shown in FIG. 3, the distributed client 200 according to the exemplary embodiment of the present invention can function as a participant in a video conference, and includes a conference participation requestor 210, a main speaker selector 220, a first-resolution packet processor 230, a second-resolution packet processor 240, an audio packet processor 250, and a display section 260.

The conference participation requestor 210 makes a request for participation in a conference while sending a video conference participation request message to the distributed controller 10.

The main speaker selector 220 selects the main speaker from among a plurality of participants in the video conference. The main speaker selector 220 selects the main speaker from among a plurality of participants displayed on the screen according to user's selection data input through an interfacing unit (e.g., keyboard, mouse, touchscreen, etc., not shown). Moreover, the main speaker selector 220 can detect the main speaker by analyzing audio data, which is extracted from audio packets received from the distributed clients participating in the conference, by the audio packet processor 250. Algorithms known to those skilled in the art may be used to detect the main speaker by analyzing audio data.

The first-resolution packet processor 230 sends or receives video packets having the first resolution, and the second-resolution packet processor 240 sends or receives video packets having the second resolution. Particularly, video packets having the first or second resolution are sent or received through the distributed media controller 20.

The display section 260 displays on the screen an image corresponding to a received video packet. Particularly, the screen of the display section 260 is divided into a first region and a second region, and the first region displays videos corresponding to video packets having the first resolution and the second region displays videos corresponding to video packets having the second resolution.

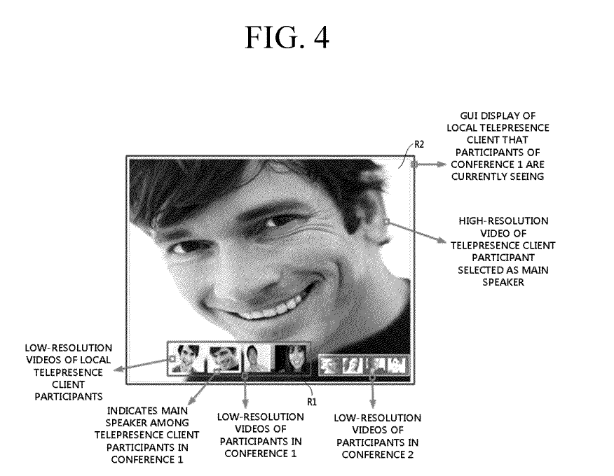

FIG. 4 is an illustration showing a screen displayed on the distributed client according to an exemplary embodiment of the present invention.

As shown in FIG. 4, the screen can be divided into a first region R1 and a second region R2, and the first region R1 displays videos corresponding to video packets sent to or received from the participants of the video conference group in which this distributed client is participating or the participants of another video conference group. For example, first-resolution videos provided from the participants of conference 1 are displayed, and first-resolution videos provided from the participants of conference 2 are also displayed. Moreover, the video of the main speaker, among the videos of the participants displayed in the first region R1, may be marked so as to identify the main speaker (e.g., the edges of the video of the main speaker are marked in a different color from the other videos).

The second region R2 displays videos corresponding to video packets sent to or received from the main speaker of the video conference group in which this distributed client is participating. Videos displayed in the first region R1 have the first resolution, and videos displayed in the second region R2 have the second resolution.

On this display screen, the user may select the main speaker from among the first-resolution videos of the plurality of participants displayed in the first region R1.

Next, a distributed video conferencing method according to an exemplary embodiment of the present invention will be described based on the video conferencing apparatus having the above-described structure.

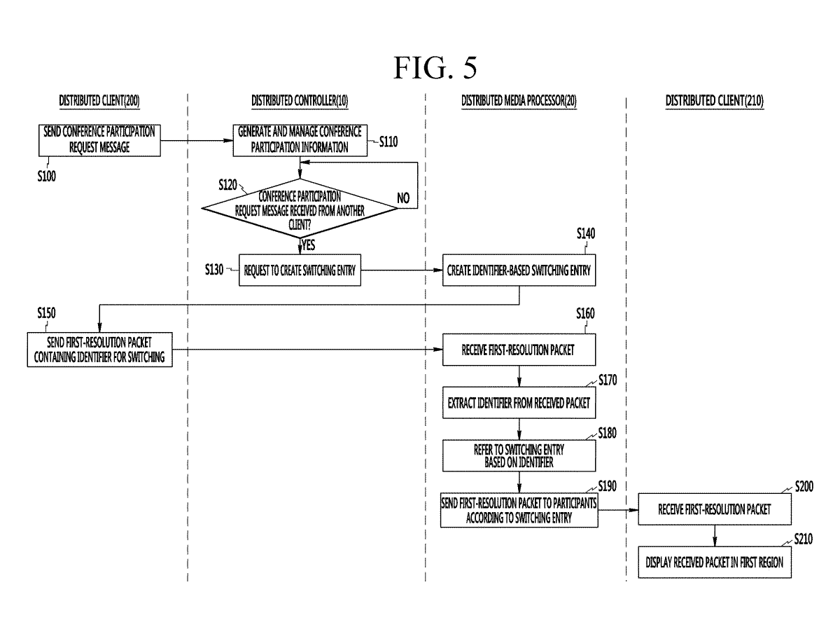

FIG. 5 is a flowchart of a distributed video conferencing method for a first-resolution packet according to an exemplary embodiment of the present invention.

A distributed client 200 who wants to participate in a video conference creates a conference participation request message and sends it to the distributed controller 10 (S100). The video participation request message can include the identifier of the distributed client. As shown in FIG. 1, the video participation request message is processed as a control packet and transmitted to the distributed controller 10 from the distributed client 200 or transmitted to the distributed controller 10 through the distributed media processor 20.

Upon receiving a conference participation request message from an arbitrary distributed client 200, the distributed controller 10 generates and manages conference participation information about the distributed client 200 based on the conference participation request message (S110). The conference participation information includes a group identifier for a video conference group in which the distributed client wants to participate, and information about participants (the identifiers, location information, etc. of individual participants), and may further include information about the distributed media processors corresponding to the participants of the video conference group. A video conference group may be created in response to a conference participation request message.

In response to conference participation request messages from distributed clients, the distributed controller 10 generates and manages conference participation information about the respective distributed clients. Video conference groups are created through this procedure, participants participate in these video conference groups, and therefore video conferencing takes place. For example, a video conference group is created in response to a conference participation request message from a first distributed client, and the distributed controller 10 allows a second distributed client to participate in the created video conference group in response to a conference participation request message from the second distributed client.

Upon receiving a conference participation request message from the second distributed client when a video conference group has been created in response to a conference participation request message from the first distributed client (S120), the distributed controller 10 requests the distributed media processors 20 to create an identifier-based switching entry for broadcasting conference data about the first and second distributed clients, i.e., video and audio packets, to the relevant video conference group (S130). Particularly, the distributed controller 10 may request the distributed media processor for the first client and the distributed media processor for the second media processor to each create an identifier-based switching entry for a first-resolution packet.

Accordingly, the distributed media processors 20 create, store, and manage an identifier-based switching entry based on the information forwarded from the distributed controller 10 (S140). The distributed media processors 20 create a switching entry for forwarding a packet, based on the identifiers of the first and second distributed clients. For example, a switching entry may be created for each video conference group, and may include the identifiers of distributed clients (e.g., first and second distributed clients) corresponding to a group identifier for a video conference group, and participating in this video conference group. Meanwhile, unique identification information may be assigned to the switching entry to indicate that this switching entry is for processing a first-resolution packet.

Thereafter, the first distributed client or the second distributed client (while the same reference numeral 200 is assigned to both of the first distributed client and the second distributed client for convenience of explanation, the present invention is not limited thereto) generates a first-resolution packet and sends it to the distributed media processor 20 (S150). Here, the first distributed client or the second distributed client may add an identifier for switching (e.g., an identifier indicative of the first resolution, a group identifier of a video conference group, etc.) to the first-resolution packet and transmits it.

The distributed media processor 20 receives the first-resolution packet from the first distributed client or second distributed client, and extracts the identifier for switching from the received first-resolution packet (S160 and S170). Then, the distributed media processor 20 identifies distributed clients to forward the packet to, by referring to the created identifier-based switching entry based on the extracted identifier (S180). For example, the distributed media processor 20 identifies the video conference group to which the first or second distributed client belongs and the other distributed clients participating in this video conference group, based on the extracted identifier.

The distributed media processor 20 identifies the participants belonging to the same video conference group by referring to the switching entry based on the extracted identifier, and sends the first-resolution packet to the identified participants (S190). The first-resolution packet may be sent to the participants directly or through other distributed media processors corresponding to the participants. For example, as shown in FIG. 1, the first-resolution packet from the distributed client 200 may be forwarded to the distributed client 210 through two distributed media processors 20.

Upon receiving the first-resolution packet from the distributed media processor 20 (S200), the distributed client 210 belonging to and participating in the same video conference group processes the received packet and outputs or displays it. Particularly, the distributed client 210 processes a first-resolution video packet and displays the corresponding video in the first region R1 of the display screen first (S210). Accordingly, the first-resolution packet received from other distributed clients belonging to the same video conference group is processed and displayed in the first region located on the bottom of the display screen, as shown in FIG. 4.

Thereafter, when a new distributed client participates in the same video conference group, the above-described processes are repeatedly carried out to display videos corresponding to first-resolution packets, sent from the participants belonging to this video conference group, on the bottom of the display screen of each of the participants belonging to the same video conference group.

Through this procedure, the first-resolution packets are sent and received between distributed clients belonging to a video conference group, through the distributed media processors 20 rather than through the distributed controller 10, thus preventing traffic of sent and received packets from being concentrated on the distributed controller 10.

Next, a distributed video conferencing method for sending and receiving a second-resolution packet according to an exemplary embodiment of the present invention will be described.

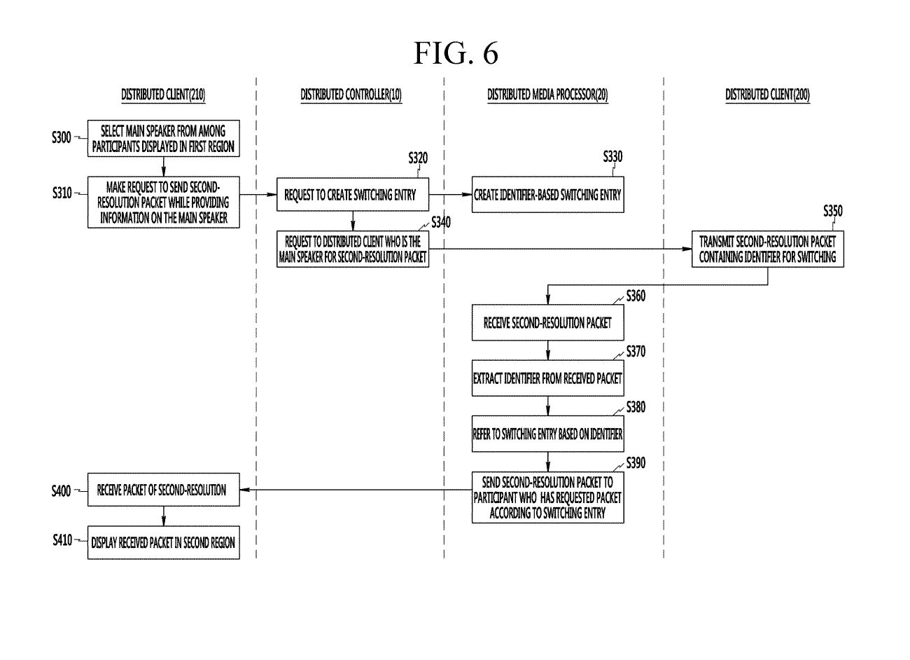

FIG. 6 is a flowchart of a distributed video conferencing method for a second-resolution packet according to an exemplary embodiment of the present invention.

While video conferencing is taking place for each video conference group, a distributed client, who is an arbitrary participant, selects the main speaker (S300). As shown in FIG. 4, while videos corresponding to participants are being displayed in the first region R1 of the display screen, a distributed client 210, who is an arbitrary participant, selects the main speaker from among the participants in the first region R1. Alternatively, the distributed client 210 may select the main speaker by analyzing audio packets received from individual distributed clients. The distributed client 210 makes a request to send a second-resolution packet while transmitting information on the distributed client corresponding to the selected main speaker to a distributed controller 10 (S310).

The distributed controller 10 requests a distributed media processor 20 to create an identifier-based switching entry for sending a second-resolution packet, in response to the request from the distributed client 210 for a second-resolution packet associated with the main speaker (S320). Here, the distributed controller 10 may send a switching entry creation request to the distributed media processor for the distributed client (which will be illustrated herein as a distributed client denoted by 200 for convenience of explanation) corresponding to the selected main speaker.

The distributed media processor 20 creates, stores, and manages an identifier-based switching entry based on information forwarded from the distributed controller 10, in response to the request from the distributed controller 10 (S330). The distributed media processor 20 creates a switching entry for forwarding a packet, based on the identifier of the distributed client 200 selected as the main speaker and the identifier of the distributed client 210 who has requested a second-resolution packet. For example, a switching entry may be created based on the identifiers of the distributed clients 200 and 210, a group identifier for a video conference group they belong to, and unique identification information indicating that this switching entry is for processing a second-resolution packet.

After requesting the distributed media processor 20 to create a switching entry, the distributed controller 10 sends a packet transmission request to the distributed client 200 selected as the main speaker (S340). At this time, if the distributed client 200, the main speaker, has already sent a second-resolution packet in response to another distributed client's request, the distributed controller 10 may not send a packet transmission request.

In response to the request from the distributed controller 10, the distributed client 200 selected as the main speaker generates a second-resolution packet and transmits it to the distributed media processor 20 (S350). Here, an identifier for switching (e.g., an identifier indicative of the second resolution, the identifier of the distributed client 200, etc.) may be added to the second-resolution packet and transmitted.

The distributed media processor 20 receives the second-resolution packet from the distributed client selected as the main speaker, and extracts the identifier for switching from the received second-resolution packet (S360 and S270). Then, the distributed media processor 20 identifies distributed clients to forward the packet to, by referring to the created identifier-based switching entry based on the extracted identifier (S380). For example, the distributed media processor 20 finds the switching entry corresponding to the distributed client 200 and the identifier of the distributed client 210 who has requested the packet contained in the switching entry, and identifies the target to send the packet to, based on the extracted identifier.

The distributed media processor 20 identifies the distributed client 200 who has requested the second-resolution packet by referring to the switching entry based on the extracted identifier, and sends the second-resolution packet to the identified distributed client 210 (S390). The second-resolution packet may be sent to the distributed client 210, directly or through another distributed media processor corresponding to the distributed client 210.

Upon receiving the second-resolution packet from the distributed media processor 20 (S400), the distributed client 210 who has selected the main speaker and requested the packet processes the received packet and outputs or displays it. Particularly, the distributed client 210 processes a second-resolution video packet and displays the corresponding video in the second region R2 of the display screen first (S410). Accordingly, the second-resolution packet sent from the distributed client selected as the main speaker is processed and displayed in the second region located at the center of the display screen, as shown in FIG. 4.

Through this procedure, traffic of sent and received packets is kept from being concentrated on the distributed controller, which is a central server, and high-resolution video packets are transmitted not to the clients of all participants, but only to a client who has requested high-resolution packets according to the selection or the main speaker, thus preventing an increased load on the network due to increased bandwidth.

According to an exemplary embodiment of the present invention, packets transmitted between participants using a video conferencing service or a telepresence service are kept from being concentrated on the distributed telepresence controller, but instead can be sent and received between the participants through the distributed telepresence media processors, based on switching entries. Accordingly, the scalability of the telepresence service can be improved because traffic of sent or received packets is not concentrated on the distributed telepresence controller, which is a central server.

Moreover, high-resolution video packets are transmitted not to the clients of all participants, but only to a client who has requested high-resolution packets according to the selection or the main speaker, thus preventing an increased load on the network due to increased bandwidth.

The exemplary embodiments of the present invention are not implemented only according to the above-described device and/or method, but can be implemented through a program for realizing functions corresponding to the configuration of the exemplary embodiments of the present invention and a recording medium having the program stored thereon. Such implementation can be easily made by a skilled person in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A video conferencing method for a video conferencing apparatus, the method comprising:
a distributed controller receiving a request from a first distributed client for a packet from a second distributed client selected as a main speaker;
a distributed media processor creating a switching entry for switching packets from the first and second distributed clients, in response to a request from the distributed controller;
the distributed controller sending a packet transmission request to the second distributed client; and
the distributed media processor receiving a packet from the second distributed client and sending the received packet to the first distributed client based on the switching entry.

2. The video conferencing method of claim 1, wherein, in the creating of a switching entry for switching a packet from the second distributed client, the identifier of the first distributed client and the identifier of the second distributed client are added to the switching entry.

3. The video conferencing method of claim 2, wherein
the sending of the received packet to the first distributed client comprises:
extracting an identifier from the packet received from the second distributed client;
identifying the first distributed client by referring to the switching entry based on the extracted identifier; and
sending the packet to the identified distributed client.

4. The video conferencing method of claim 1, further comprising:
upon receiving a conference participation request message from a third distributed client, the distributed controller requesting the distributed media processor to create a switching entry;
the distributed media processor creating an identifier-based switching entry for a video conference group to which the third distributed client belongs;
the distributed media processor receiving a packet from the third distributed client; and
the distributed media processor transmitting the packet to the distributed clients corresponding to the participants belonging to the video conference group.

5. The video conferencing method of claim 4, wherein
in the generating of an identifier-based switching entry,
a group identifier assigned to the video conference group, the identifier of the third distributed client, and the identifiers of the distributed clients participating in the video conference group are added to the switching entry.

6. The video conferencing method of claim 5, wherein
the transmitting of the packet to the distributed clients comprises:
extracting the group identifier or the identifier of the third distributed client from the packet;
acquiring the identifiers of the distributed clients, i.e., the participants, by analyzing the switching entry based on the extracted identifier; and
transmitting the packet to the distributed clients corresponding to the acquired identifiers.

7. The video conferencing method of claim 4, wherein the packet received from the third distributed client is a packet having a first resolution that is lower than a set resolution, and the packet received from the second distributed client is a packet having a second resolution that is higher than the set resolution.

8. The video conferencing method of claim 4, further comprising:
when a distributed client receives a first-resolution packet, displaying, on a display screen divided into a first region and a second region, a video corresponding to the first-resolution located below the second region; and
when the distributed client receives a second-resolution packet, displaying a video corresponding to the second-resolution packet in the second region.

9. The video conferencing method of claim 8, further comprising
prior to the receiving of a packet request from the first distributed client,
the first distributed client selecting one of the videos having the first resolution displayed in the first region, and selecting the distributed client who has provided the selected video as the main speaker.

10. The video conferencing method of claim 7, wherein
in the sending of a packet transmission request to the second distributed client,
if the second distributed client has transmitted a second-resolution packet in response to a request from another distributed client, the distributed controller does not send a packet transmission request based on the request from the first distributed client.

11. A video conferencing apparatus which conducts video conferencing between a plurality of distributed clients, the apparatus comprising:
a plurality of distributed media processors that send or receive packets to and from the plurality of distributed clients and correspond to the plurality of distributed clients; and
a distributed controller that requests the distributed media processors to create an identifier-based switching entry for packet transmission to the distributed media processors, upon receiving a conference participation request from the distributed clients or a request from the distributed clients for a packet from the distributed client who is a main speaker,
wherein each of the distributed media processors creates a switching entry and transmits a packet received from the distributed clients to other distributed clients, based on the created switching entry.

12. The video conferencing apparatus of claim 11, further comprising:
a packet receiver that receives a packet from the distributed clients;
a switching entry processor that creates an identifier-based switching entry in response to a request from the distributed controller;
an identifier processor that extracts an identifier from the packet received from the distributed clients, and creates a switching entry based on the extracted identifier to identify a target to send the packet to; and
a packet transmitter that transmits the received packet to the distributed client corresponding to the identified target.

13. The video conferencing apparatus of claim 11, wherein
the switching entry processor generates a first switching entry for switching packets from the first distributed client and second distributed client selected as the main speaker and a second switching entry for switching a packet from the third distributed client, and
the second switching entry is used for switching a packet having a first resolution that is lower than a set resolution, and the first switching entry is used for switching a packet having a second resolution that is higher than the set resolution.

14. The video conferencing apparatus of claim 13, wherein
the first switching entry is created based on the identifier of the first distributed client and the identifier of the second distributed client, and
the second switching entry is created based on a group identifier assigned to the video conference group to which the third distributed client belongs, the identifier of the third distributed client, and the identifiers of the distributed clients participating in the video conference group.

15. The video conferencing apparatus of claim 13, wherein
the distributed controller requests the second distributed client to provide a second-resolution packet in response to a request from the first distributed client, who is the main speaker, and
the distributed media processor forwards the second-resolution packet received from the second distributed client to the first distributed client based on the first switching entry.

16. The video conferencing apparatus of claim 13, wherein the distributed media processor sends the first-resolution packet received from the third distributed client to other distributed clients belonging to the same video conference group as the third distributed client, based on the second switching entry.

17. A distributed client device, which conducts video conferencing via a network in connection with a video conferencing apparatus including a distributed controller and distributed media processors, the device comprising:
a conference participation requestor that makes a request for participation in a conference while sending a video conference participation request message to the distributed controller;
a first-resolution packet processor that sends or receives packets having a first resolution that is lower than a set resolution;
a second-resolution packet processor that sends or receives packets having a second resolution that is higher than the set resolution; and
a display section that divides the display screen into a first region and a second region, the first region displaying videos corresponding to first-resolution video packets, and the second region displaying videos corresponding to second-resolution video packets.

18. The distributed client device of claim 17, further comprising a main speaker selector that selects the main speaker from among a plurality of participants in the video conference,
wherein the second-resolution packet processor receives a second-resolution packet sent from the distributed client selected as the main speaker.

19. The distributed client device of claim 18, wherein the main speaker selector selects the main speaker from among a plurality of participants who have provided the first-resolution packets displayed in the first region.
